(19) United States
(12) Patent Application Publication
(10) Pub. No.: US 2008/0308351 A1
(43) Pub. Date: Dec. 18, 2008

(54) Drain plug bolt

(76) Inventor: Paul Godek, Alexandria, VA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/812,380

(22) Filed: Jun. 18, 2007

(51) Int. Cl. F16N 33/00

(52) U.S. Cl. 184/1.5; 137/454.5; 251/100

(57) ABSTRACT

The drain plug bolt includes a shank having a head and tip. An interior bore extends longitudinally from the tip for a predetermined distance less than the shank total length. The shank includes an externally threaded portion distal to the head, an externally threaded portion proximal to the head, and an unthreaded middle portion between the distal and proximal portions of the shank. The middle portion includes a counter-bore that forms a drain hole and extends from a radial surface of the shank middle portion to the longitudinally extending internal bore to create a passageway that leads from the internal bore to the exterior of the drain plug. Tightening the drain plug against the fluid reservoir, retains fluid within the reservoir. Loosening, the drain plug until the distal threads are in communication with the fluid reservoir allows fluid to escape the reservoir via the passageway in the drain plug.

### BACKGROUND OF THE INVENTION

1. Field of the Invention

The present invention relates generally to the field of fluid reservoirs and more specifically to the leak-proof retention of, and easy removal of fluids from various reservoirs found within vehicles, machinery, and the like.

2. Description of the Related Art

The problems with draining fluids from a reservoir are well known. Perhaps most familiar are the problems with draining engine oil from the oil pan of a car or truck engine. When the drain plug is removed, oil splashes onto hands and tools, the bolt is easily dropped, and the oil arcs out of the drain hole in an uneven stream. Typical drain plugs currently available do not solve the aforementioned problems.

Alternative drain plugs that attempt to solve the problem may have complex mechanisms which may require applying suction to remove the fluid from the reservoir. What is needed is a simple, one-piece device that relies on gravity as the force behind the evacuation process so as to avoid these complex mechanisms.

Thus, a drain plug bolt solving the aforementioned problems is desired.

### SUMMARY OF THE INVENTION

The drain plug bolt can be used in place of a standard oil plug during the removal of lubricants, fuels, or other fluids from an engine, transmission, gear box, differential, fuel reservoirs found in automobiles, industrial equipment or machines, heavy earth moving equipment, agricultural farming equipment, or any machines operated by internal combustion engines, or any machines using lubricants, fuels, coolants, or the like. The present invention accomplishes this by replacing the current oil plug with a hollow bolt having a drain hole in the side to give passage of the reservoir fluids to the outside when the bolt is partially loosened from the reservoir. According to the present invention, the drain plug bolt includes a shank having a head and tip. An interior bore extends longitudinally from the tip for a predetermined distance less than the shank total length. The shank includes an externally threaded portion distal to the head, an externally threaded portion proximal to the head, and an unthreaded middle portion between the distal and proximal portions of the shank. The middle portion includes a counter-bore that forms a radial surface drain hole and extends therefrom to the longitudinally extending internal bore in order to complete a passageway that leads from the internal bore and the counter-bore to the exterior of the drain plug bolt via the radial surface drain hole. Tightening the drain plug against the fluid reservoir, retains fluid within the reservoir. Loosening, the drain plug until the distal threads are in communication with a wall of the fluid reservoir allows fluid to escape the reservoir via the passageway and drain hole of the drain plug.

These and other features of the present invention will become readily apparent upon further review of the following specification and drawings.

### BRIEF DESCRIPTION OF THE DRAWINGS

FIG. 1A is an environmental, perspective view of a hollow drain plug in a sealed position according to the present invention.

FIG. 1B is an environmental, perspective view of a hollow drain plug in an unsealed position according to the present invention.

FIG. 2 is a partial section view of a hollow drain plug according to the present invention.

Similar reference characters denote corresponding features consistently throughout the attached drawings.

### DETAILED DESCRIPTION OF THE PREFERRED EMBODIMENT

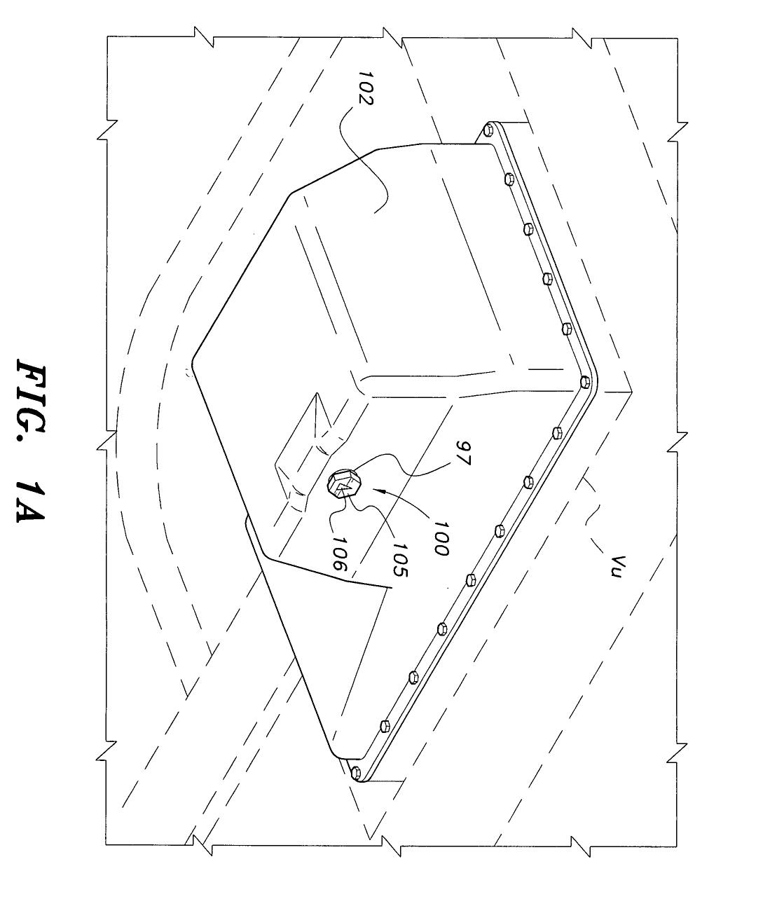

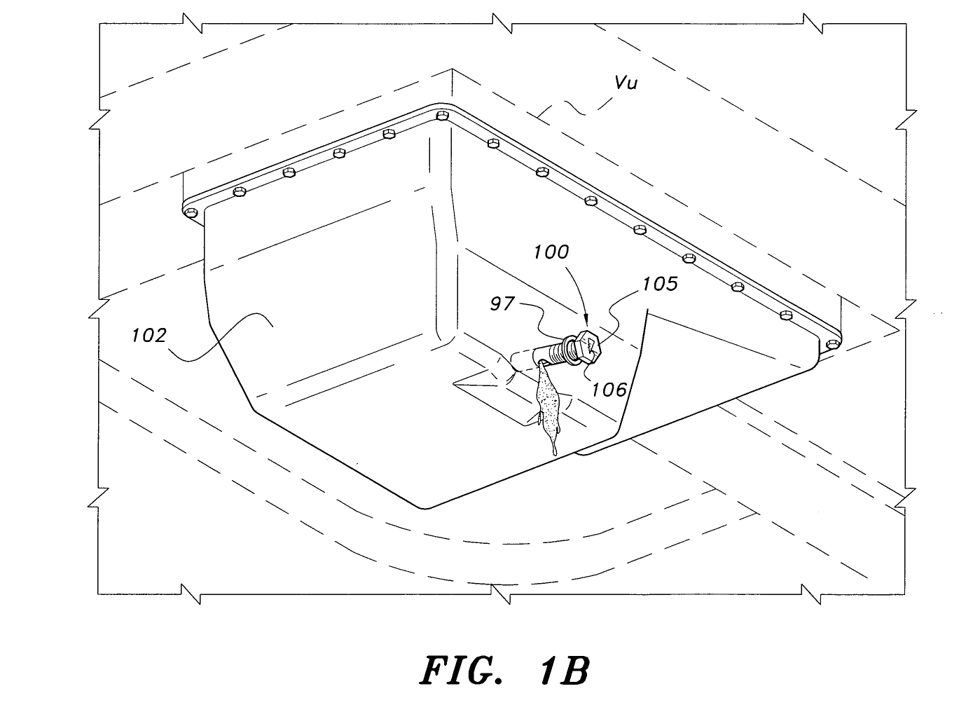

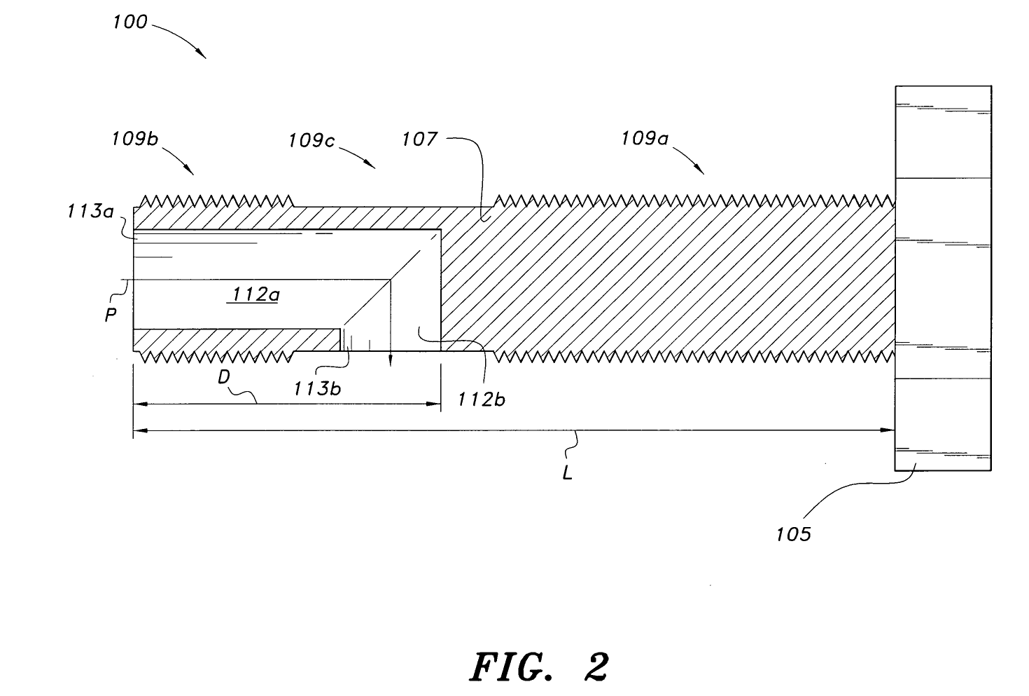

As shown in FIGS. 1A-2, the present invention is a drain plug bolt 100 that includes a shank 107 having a head 105 and tip 113a. The head 105 may be formed to fit any type of bolt driving tool, including, for example, but not limited to hexagonal driving tools, Allen driving tools, and the like. The head 105 may be adapted for a driving tool that can fit over the head 105 and/or the head 105 may have a socket adapted for a driving tool that can fit inside the socket of the head 105. An interior bore 112a extends longitudinally from the tip 113a for a predetermined distance D less than the shank total length L. The shank 107 includes an externally threaded portion 109b distal to the head 105, an externally threaded portion 109a proximal to the head 105, and an unthreaded middle portion 109c disposed between the distal portion 109b and the proximal portion 109a of the shank 107. The middle portion 109c includes a counter-bore 112b that forms radial surface drain hole 113b and extends therefrom to the longitudinally extending internal bore 112a in order to complete a passageway P that leads from the internal bore 112a and the counter-bore 112b to the exterior of drain plug bolt 100 via radial surface drain hole 113b. Preferably unthreaded middle portion 109c is disposed between the threaded portions 109b and 109a so that the unthreaded portion 109c extends beyond the drain hole 113b in both longitudinal directions along shank 107.

Tightening the drain plug 100 against the fluid reservoir retains fluid within the reservoir. A washer/gasket 97 may be fitted over the shank 107 of drain plug bolt 100 to help seal the fitting to the fluid reservoir, e.g., oil pan 102 on vehicle undercarriage VU. Loosening the drain plug 100 past the proximal threaded section 109a allows the bolt to be slipped out past the unthreaded section 109c, until the distal threads 109b come in contact with the wall of the fluid reservoir. The bolt is held in place by the distal threaded section 109b while the oil drains through the hollow core 112a and 112b.

Direction of flow of the escape fluid may be guided/predicted by lining up arrow/other indicia 106 in the desired direction, since arrow 106 is disposed on head 105 in a direction that corresponds with orientation of drain hole 113b. If the bolt 100 and fluid reservoir pan 102 are designed together, the threads can be set so that the drain hole is pointing downward when the first threaded section releases.

Almost all of the oil will drain out even if the drain bolt is not entirely removed. The bolt can be fully removed, however, to drain the last amounts of oil or to replace the washer that is typically used.

It is to be understood that the present invention is not limited to the embodiment described above, but encompasses any and all embodiments within the scope of the following claims.

I claim:

1. A drain plug bolt adapted for being threaded into a fluid reservoir, the drain plug bolt comprising:
a shank having a head and a tip;
an interior bore extending longitudinally from the tip of the shank for a predetermined distance that is less than a total length of the shank;
the shank including an externally threaded portion distal to the head, an externally threaded portion proximal to the head, and an unthreaded middle portion disposed between the distal and proximal portions of the shank;
the middle portion including a counter-bore that extends from a radial surface of the middle portion of the shank to the longitudinally extending internal bore of the shank in order to form a drain hole and a passageway that connects the internal bore to the drain hole; and
wherein when the drain plug is tighteningly threaded against the fluid reservoir having the proximal threads in communication with a wall of the fluid reservoir, fluid is retained within the fluid reservoir, and when the drain plug is loosened, having the distal threads in communication with the wall of the fluid reservoir, fluid held by the reservoir is permitted to escape out of the drain hole via the passageway in the drain plug.

2. The drain plug bolt according to claim 1, further comprising: a gasket that can be fitted over the shank of the drain plug bolt to help seal the fitting to the fluid reservoir.

3. The drain plug bolt according to claim 1, further comprising: indicia disposed on the head of the drain plug bolt, said indicia indicating a direction that corresponds with an orientation of the drain hole.

4. The drain plug bolt according to claim 1, wherein the unthreaded middle portion is disposed between the threaded portions so that the unthreaded portion extends beyond the drain hole in both longitudinal directions along shank.

5. The drain plug bolt according to claim 1, wherein the fluid reservoir is an oil pan of a motor vehicle.

6. A drain plug bolt adapted for being threaded into a fluid reservoir, the drain plug bolt comprising:
a shank having a head and a tip;
an interior bore extending longitudinally from the tip of the shank for a predetermined distance that is less than a total length of the shank;
the shank including an externally threaded portion distal to the head, an externally threaded portion proximal to the head, and an unthreaded middle portion disposed between the distal and proximal portions of the shank;
the middle portion including a counter-bore that extends from a radial surface of the middle portion of the shank to the longitudinally extending internal bore of the shank in order to form a drain hole and a passageway that connects the internal bore to the drain hole;
indicia disposed on the head of the drain plug bolt, said indicia indicating a direction that corresponds with an orientation of the drain hole; and
wherein when the drain plug is tighteningly threaded against the fluid reservoir having the proximal threads in communication with a wall of the fluid reservoir, fluid is retained within the fluid reservoir, and when the drain plug is loosened, having the distal threads in communication with the wall of the fluid reservoir, fluid is permitted to escape out of the drain hole in a direction indicated by the indicia via the passageway of the drain plug.

7. The drain plug bolt according to claim 6, further comprising: a gasket that can be fitted over the shank of the drain plug bolt to help seal the fitting to the fluid reservoir.

8. The drain plug bolt according to claim 6, wherein the unthreaded middle portion is disposed between the threaded portions so that the unthreaded portion extends beyond the drain hole in both longitudinal directions along shank.

9. The drain plug bolt according to claim 6, wherein the fluid reservoir is an oil pan of a motor vehicle.

10. A drain plug bolt adapted for being threaded into a fluid reservoir, the drain plug bolt consisting of:
a shank having a head and a tip;
an interior bore extending longitudinally from the tip of the shank for a predetermined distance that is less than a total length of the shank;
the shank including an externally threaded portion distal to the head, an externally threaded portion proximal to the head, and an unthreaded middle portion disposed between the distal and proximal portions of the shank; the middle portion including a counter-bore that extends from a radial surface of the middle portion of the shank to the longitudinally extending internal bore of the shank in order to form a drain hole and a passageway that connects the internal bore to the drain hole;
indicia disposed on the head of the drain plug bolt, said indicia indicating a direction that corresponds with an orientation of the drain hole; and
wherein when the drain plug is tighteningly threaded against the fluid reservoir having the proximal threads in communication with a wall of the fluid reservoir, fluid is retained within the fluid reservoir, and when the drain plug is loosened, having the distal threads in communication with the wall of the fluid reservoir, fluid held by the reservoir is permitted to escape out of the drain hole in a direction indicated by the indicia via the passageway in the drain plug.

11. The drain plug bolt according to claim 10, wherein the fluid reservoir is an oil pan of a motor vehicle.

12. The drain plug bolt according to claim 10, wherein the unthreaded middle portion is disposed between the threaded portions so that the unthreaded portion extends beyond the drain hole in both longitudinal directions along shank.

13. The drain plug bolt according to claim 10, wherein using the externally threaded portion of the drain plug bolt distal to the head, the drain plug bolt can be fully removed from the fluid reservoir pan to drain remaining amounts of fluid.
